(19) United States
(12) Patent Application Publication
(10) Pub. No.: US 2019/0118279 A1
(43) Pub. Date: Apr. 25, 2019

(54) Welding Gas Sensor

(71) Applicant: Timothy Lee Welsh, Alexandria, MN (US)

(72) Inventor: Timothy Lee Welsh, Alexandria, MN (US)

(21) Appl. No.: 15/791,368

(22) Filed: Oct. 23, 2017

(51) Int. Cl. B23K 5/00

(52) U.S. Cl. CPC B23K 5/00

(57) ABSTRACT

A system comprising a welding machine having a control box; a welding gun electrically connected to the control box; a gas cylinder; a first gas line extending from the gas cylinder to the control box; a second gas line extending from the control box to the welding gun; a wire feed device that feeds wire to the welding gun; and a sensor. The sensor is configured to monitor the amount of gas in the gas supply. When the sensor senses that the amount of gas has reached or gone below a threshold level, it shuts off the wire feed device.

### FIELD OF THE INVENTION

This invention is related to a gas sensor for welding machines and in particular to a gas sensor that is able to determine when the gas supply for a welding machine is out of gas or nearly out of gas.

### BACKGROUND

Gas welding machines produce a flame from a welding gun. A user directs the flame to a work site on a work piece in order to reform the metal through melting and/or fusion methods. The welding machine may also feed a wire or filler material to the work site. The welding machine produces the flame upon the combustion of a mixture of air or other oxygen-containing gases with a suitable fuel. The fuel is generally provided in gas storage cylinders or tanks. However, if a gas cylinder runs out of gas while welding is still being performed, a weld metal contamination referred to as porosity may occur. Porosity is a series of tiny holes throughout the affected portion of the weld which makes the weld defective. Porosity may be caused by released gases becoming trapped in the weld metal. When porosity occurs, it leaves unsightly raised patches on the worked surface. Generally, when porosity occurs, the user may be required to grind the entire defective portion from the work.

### SUMMARY

A system may comprise a welding machine having a control box; a welding gun electrically connected to the control box; a gas cylinder; a first gas line extending from the gas cylinder to the control box; a second gas line extending from the control box to the welding gun; and a sensor; wherein the sensor is configured to monitor the amount of gas in the gas supply. The sensor may be disposed on the gas cylinder. Alternatively, the sensor may be disposed on the first gas line. The sensor may be electrically connected to the control box. The sensor may be configured to sense the amount of gas remaining in the gas cylinder.

The system may further include a supply of wire and a wire feed device. The wire feed device may be configured to feed the wire to the welding gun. The sensor may send a signal to the control box when the sensor senses that the supply of gas in the gas cylinder has reached or gone below a predetermined threshold level.

The system may further include an automatic shut-off electrically connected to the wire feed device. The control box may be configured to send a signal to the automatic shut-off when the control box receives a signal that the supply of gas remaining in the gas cylinder has reached or gone below the predetermined threshold level.

The automatic shut-off may be configured to stop the wire feed device from feeding wire to the welding gun when the automatic shut-off receives a signal that the supply of gas remaining in the gas cylinder has reached or gone below the predetermined threshold level.

### BRIEF DESCRIPTION OF THE FIGURES

FIG. 1 is a perspective view of a welder described herein, including the sensor.

FIG. 2 is a flow chart of some of the steps in the process as described herein.

FIG. 3 is a side view of the welder of FIG. 1.

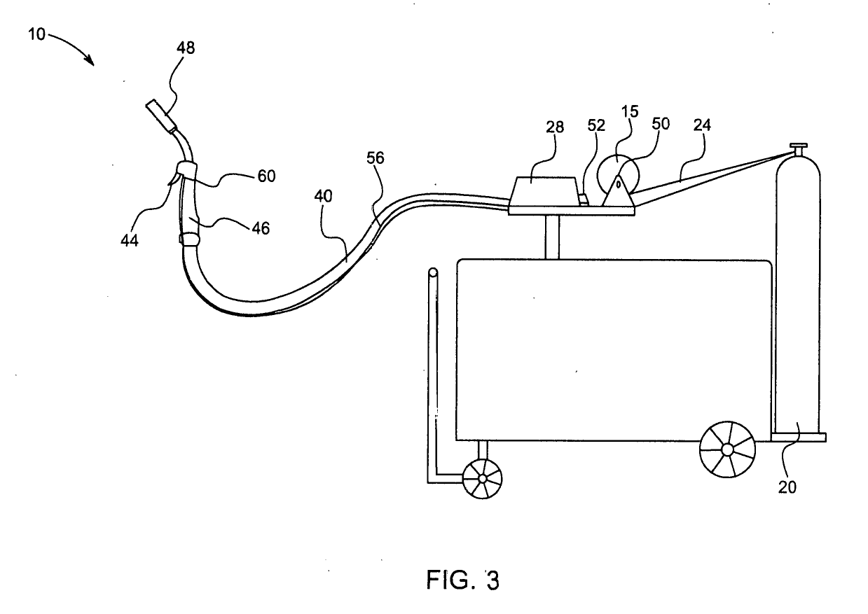

### DETAILED DESCRIPTION

A welding system including a gas sensor that alerts a user or that shuts off a wire feeding device when a welding machine is running out of gas is described. The sensor of the welding system may interface with the wire feeding device on the welding machine. The sensor may send a signal to the wire feed mechanism to stop the wire feed when the sensor detects that the gas supply has run out or has nearly run out.

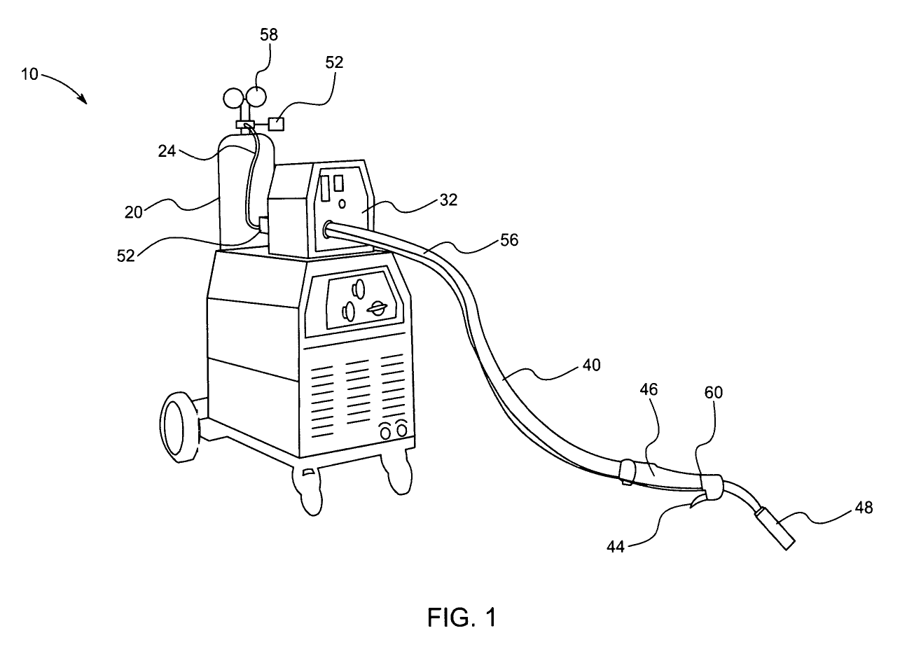

Referring now to FIG. 1, a welding machine 10 may be equipped with at least one gas cylinder or gas tank 20. A gas hose 24 may extend between the gas tank 20 of the welding machine 10 and a control box 28. The control box 28 may have a panel 32 that allows a user to control the at least one of the gas feed, voltage being supplied to the device, the rate of feed of wire or filler material, and other operations of the welding machine 10. The panel 32 may allow the user to control other functions, and it may give readouts and status updates to the user.

The welding machine 10 may be provided with wire or filler material and a device to feed the wire or filler material 15 to a welding gun 46. The wire or filler material may be stored on a spool 50. The wire or filler material may extend from the spool 50 on the welding machine 10 along a welding gas hose 40. A wire feed device or spool may feed wire to a welding gun 46 of the welding machine 10.

The welding gas hose 40 may extend from control box 28 of the welding machine 10 to the welding gun 46. A trigger 44 disposed on welding gun 46 may allow the user to control the functions of the welding machine. Squeezing or pressing the trigger 44 may start the welding process, and may cause gas to move through the hose 40 to a cone 48, and may cause the wire feed device 50 to feed wire or filler material to cone 48.

Electrical wiring 56 may extend from the control box 28 to the trigger 44 of the welding machine 10. The wire may electrically connect the trigger 44 to the control box 28, and allow a user to regulate the speed of the wire feed by varying the pressure on the trigger.

In an embodiment, a sensor 52 may be disposed on the hose extending between the gas tank 20 and the control box 28. In an alternative embodiment, sensor 52 may be disposed directly on gas tank 20 or on regulator 58 of gas tank 20. Sensor 52 may be a pressure sensor, a weight sensor, or other type of sensor. Sensor 52 may measure the concentration of the gas in the tank or travelling through hose 40.

Sensor 52 may be electrically connected to control box 28. Sensor 52 may be electrically connected to the wire feed device 50. Sensor may be connected to an automatic shut-off device 60 at trigger 44 of welding gun 46. Automatic shut-off device may be configured to stop the flow of wire once the sensor senses that the gas supply in the cylinder 20 has run out or has nearly run out.

In an embodiment, a threshold level of gas may be set by the user, although a default threshold level may be used. In an alternative embodiment, the threshold level of gas may be pre-set. The threshold level of gas may be sufficiently high that the wire feed stops before the gas in gas cylinder 20 runs out, although there may be very little gas left in the cylinder 20 when the gas reaches the threshold level.

In an embodiment, sensor 52 may send a signal when the pressure or volume of gas in gas cylinder 20 reaches the predetermined threshold level of gas. The sensor 52 may send the signal to the control box 28. The control box 28 may then send a signal to the automatic shut-off 60. The automatic shut-off may stop the feed of the wire or filler material to the welding gun 46. Automatically stopping the feed of wire of filler material may prevent porosity in welds by preventing wire or filler material from being fed to the welding gun once the gas supply has run out. Once the wire feed stops, the user may change out the gas tank or cylinder, removing the empty gas cylinder and replacing it with a full cylinder. Sensor 52 may then sense the gas level in the new cylinder 20. Once sensor 52 senses a sufficient quantity or concentration of gas in the cylinder, the wire feed device 50 may continue to allow the wire to feed.

In an embodiment, sensor 52 may be configured to sound an audible alert when the pressure or volume of gas in gas cylinder 20 reaches the predetermined threshold level of gas in the cylinder 20. The user may stop welding upon hearing the audible alarm, and change the gas cylinder, removing the empty gas cylinder and replacing it with a full gas cylinder.

When the trigger 44 of welding gun 46 is pressed, gas may flow from the gas cylinder 20 through the gas sensor 52 to the welding gun and out the cone 48. An electrical wire 56 extends along the welding gas hose 40 to the trigger 44. When the trigger 44 is pulled, the electrical wire sends a signal to the wire feed device to start feeding wire to the cone. A second electrical wire 56 may extend from the control box 28 along the interior of the welding gas hose 40 to the trigger 46. The second electrical wire 56 may extend along the exterior of the welding gas hose 40, or it may be disposed within and extend along an interior wall of the welding gas hose 40. When the sensor 52 senses that the gas supply in the gas cylinder 20 is exhausted or nearly exhausted, the sensor may send a signal to the control box 28. Upon receiving that signal, the control box 28 may send a signal through the second electrical wire 56 to stop the wire feed. The signal may be sent to the automatic shut-off device 60. Automatic shut-off device 60 may be disposed on trigger 44 of the welding gun 46. Once the automatic shut-off device 60 receives the signal, it may stop send a signal to stop the wire feed to the welding gun 46. Stopping the wire feed may prevent porosity in the weld.

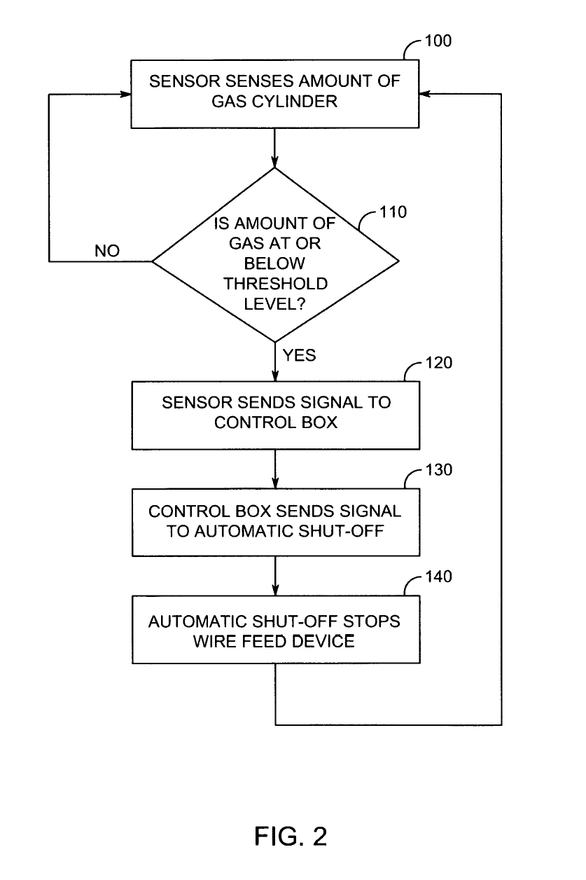

As shown in FIG. 2, the process has several steps. In the first step 100, the sensor 52 senses the level or amount of gas in the gas cylinder 20. In the second step 110, the sensor 52 may determine whether the amount of gas in the gas cylinder 20 has reached or gone below the predetermined threshold level. If the gas has not, the sensor 52 may continue to sense the level or amount of gas in the gas cylinder 20. If it has, as shown in the third step 120, the sensor may send a signal to the control box 28 that the gas level or amount has reached or gone below the predetermined threshold level. Upon receiving this signal, as shown in the fourth step 130, the control box may send a signal to the automatic shut-off 60. At that point, the automatic shut-off may stop the wire feed device from feeding wire to the welding gun, as shown in the fifth step 140.

I claim:

1. A system comprising:
a welding machine having a control box;
a welding gun electrically connected to the control box;
a gas cylinder;
a first gas line extending from the gas cylinder to the control box;
a second gas line extending from the control box to the welding gun; and
a sensor;
wherein the sensor is configured to monitor the amount of gas in the gas supply.

2. The system of claim 1, wherein the sensor is disposed on the gas cylinder.

3. The system of claim 1, wherein the sensor is disposed on the first gas line.

4. The system of claim 1, wherein the sensor is electrically connected to the control box.

5. The system of claim 4, further comprising a supply of wire and a wire feed device, wherein the wire feed device is configured to feed the wire to the welding gun.

6. The system of claim 5, wherein the sensor is configured to sense the amount of gas remaining in the gas cylinder.

7. The system of claim 6, wherein the sensor sends a signal to the control box when the sensor senses that the supply of gas in the gas cylinder has reached or gone below a predetermined threshold level.

8. The system of claim 7, further comprising an automatic shut-off electrically connected to the wire feed device; wherein the control box is configured to send a signal to the automatic shut-off when it receives a signal that the supply of gas remaining in the gas cylinder has reached or gone below the predetermined threshold level.

9. The system of claim 8, wherein the automatic shut-off is configured to stop the wire feed device from feeding wire to the welding gun when the automatic shut-off receives a signal that the supply of gas remaining in the gas cylinder has reached or gone below the predetermined threshold level.
